(19) United States
(12) Patent Application Publication
(10) Pub. No.: US 2018/0222674 A1
(43) Pub. Date: Aug. 9, 2018

(54) INDUCTIVE RECEIVING DEVICE

(71) Applicant: Michael SHEK, San Mateo, CA (US)

(72) Inventor: Michael SHEK, San Mateo, CA (US)

(21) Appl. No.: 15/424,144

(22) Filed: Feb. 3, 2017

(51) Int. Cl. B65F 1/16; E05F 11/14

(52) U.S. Cl. CPC B65F 1/1638; B65F 1/163; E05F 11/14; E05Y 2900/20; B65F 2210/128; E05Y 2201/686; E05Y 2201/71; B65F 2210/168

(57) ABSTRACT

An inductive receiving device is provided, including a main body and an actuating unit which has at least one contact portion, a processing unit and a driving unit. The main body has a shell body which has a through opening normally blocked by a blocking portion of a doorstop assembly, and when the doorstop assembly is in an opening position. The processing unit is in communication with the at least one contact portion and the driving unit, the driving unit is connected to the doorstop assembly, the contact portion transfers a pressure variation into an opening signal and transmitting the opening signal to the processing unit, as receiving the opening signal, the processing unit transmits an actuating signal to the driving unit, and the driving unit drives the doorstop assembly to swing to the opening position.

### BACKGROUND OF THE INVENTION

### Field of the Invention

The present invention relates to a receiving device.

### Description of the Prior Art

In daily life, people usually buy receiving devices, such as trash cans or storage boxes, to reserve or store objects; therefore, it is obvious that the receiving device is in great demand, so a lot of businesses develop different shapes of receiving devices to be used in different environments. Furthermore, in order to decrease a volume and improve an appearance and separate an interior of the receiving device from outside, an obliquely-open receiving device is provided, as disclosed in CN205338222 and CN205150820.

In this type of receiving device, when a user wants to put objects therein, s/he needs to lift or pull a door by hand, and the more area of the user's hand contacting the receiving device, the easier for the user to apply force thereon. When the object has dirt thereon, the dirt is easily transferred to the user's hand and further onto the receiving device, and likewise, the dirt on the receiving device is easily transferred to the user's hand. In addition, the user often applies too much force on the receiving device and causes a structure of the receiving device to be damaged, and a service life of the receiving device is not long.

The present invention has arisen to mitigate and/or obviate the afore-described disadvantages.

### SUMMARY OF THE INVENTION

The major object of the present invention is to provide an inductive receiving device, after a user contacts a contact portion, and the contact portion senses a variation of pressure, a doorstop assembly will open automatically. It is convenient and hygienic that the user does not have to contact the receiving device many times. In addition, the inductive receiving device can ensure that the user does not have to apply a great force to open the inductive receiving device, so the inductive receiving device is not damaged easily and has a preferable service life.

To achieve the above and other objects, an inductive receiving device is provided, including a main body and an actuating unit. The main body has a shell body and a doorstop assembly, the shell body has a through opening and a receiving space, the through opening is for communicating an outside of the main body and the receiving space, a blocking portion of the doorstop assembly normally blocks the through opening, the doorstop assembly optionally swings relative to the shell body to an opening position to make the blocking portion uncover the through opening, and when the doorstop assembly is in the opening position, the blocking portion is oblique to an opening direction of the through opening. The actuating unit has at least one contact portion, a processing unit and a driving unit, the processing unit is respectively in communication with the at least one contact portion and the driving unit, the driving unit is connected to the doorstop assembly, the contact portion is for being contacted from the outside of the main body, transferring a pressure variation into an opening signal and transmitting the opening signal to the processing unit, as the processing unit receives the opening signal, the processing unit transmits an actuating signal to the driving unit, and the driving unit drives the doorstop assembly to swing to the opening position.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an embodiment of the present invention;

FIG. 2 is a breakdown view of the embodiment of the present invention;

FIG. 3 is a partially-enlarged view of FIG. 2; and

FIGS. 4 and 5 are drawings of the embodiment of the present invention in operation.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

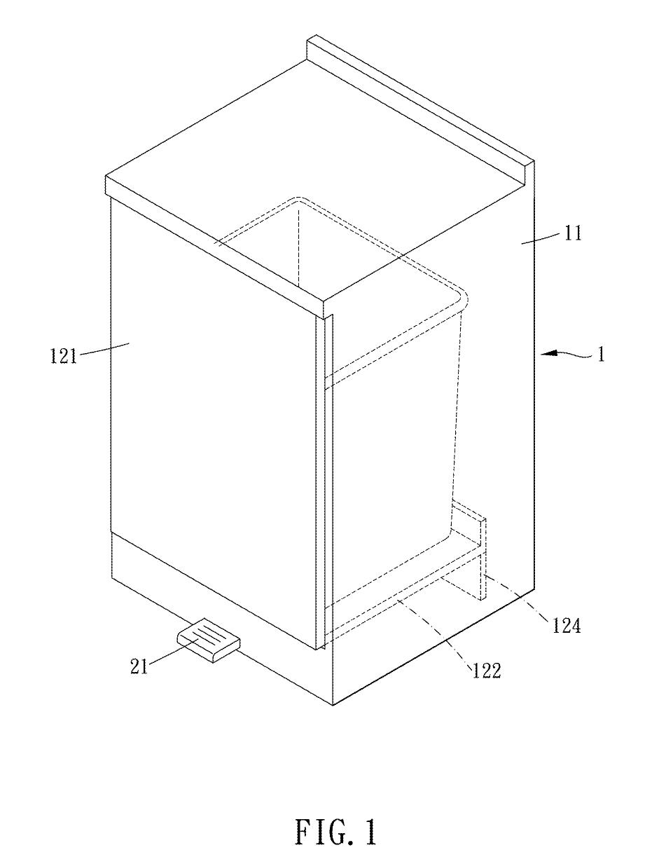

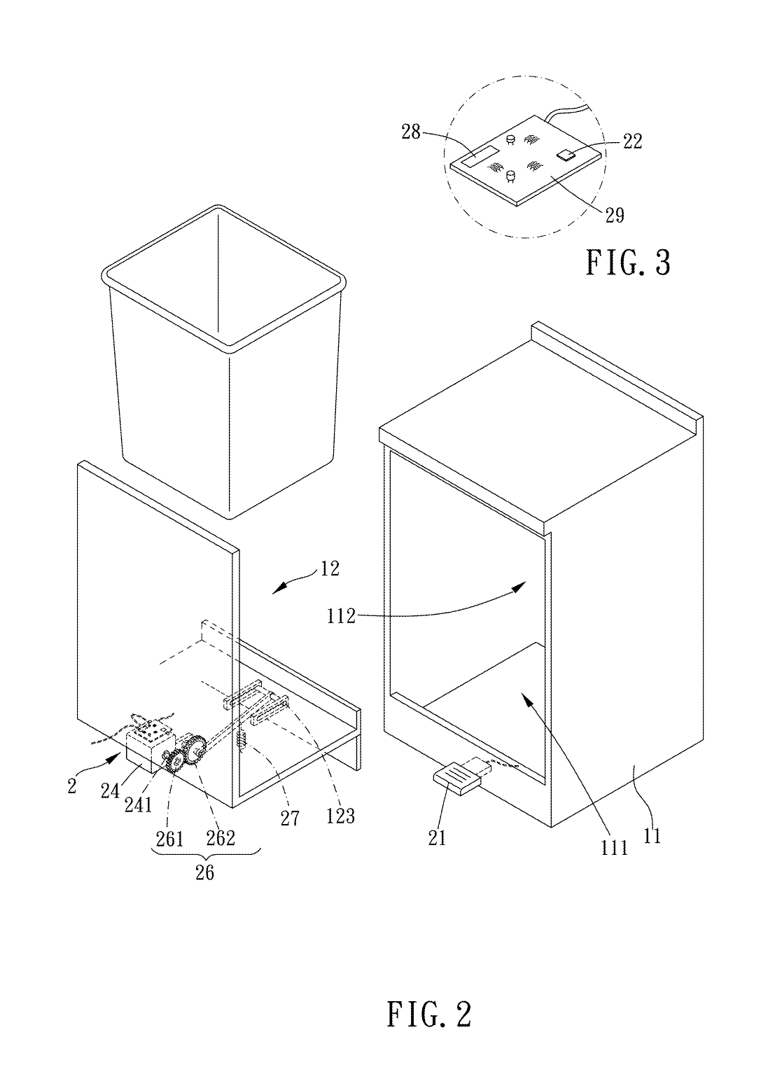

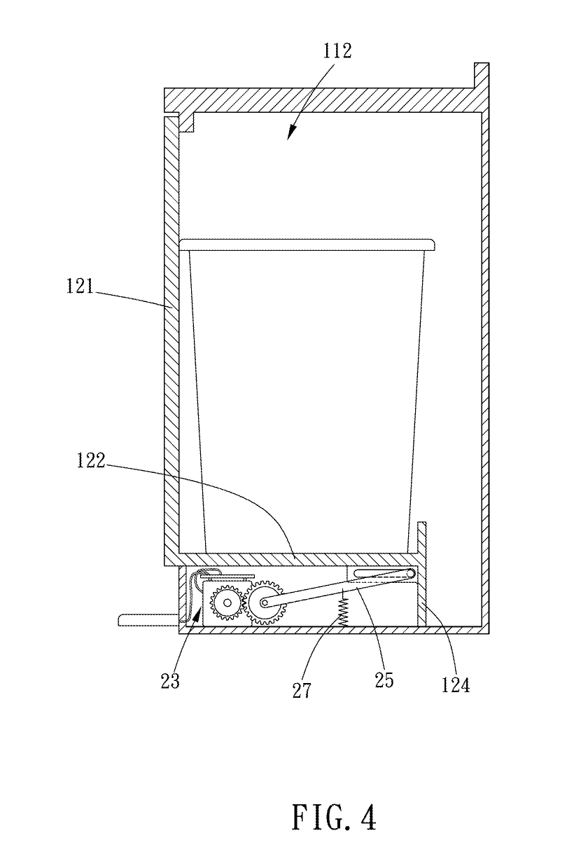

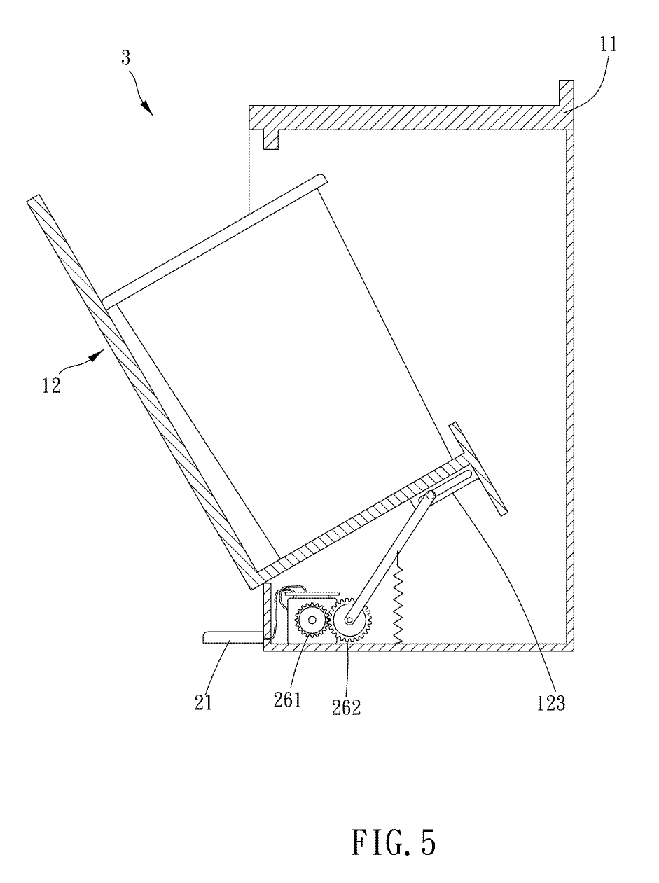

Please refer to FIGS. 1 to 5 for a preferred embodiment of the present invention. The inductive receiving device includes a main body 1 and an actuating unit 2.

The main body 1 has a shell body 11 and a doorstop assembly 12, the shell body 11 has a through opening 111 and a receiving space 112, the through opening 111 is for communicating the receiving space 112 with an outside of the main body 1, a blocking portion 121 of the doorstop assembly 12 normally blocks the through opening 111, and the doorstop assembly 12 optionally swings relative to the shell body 11 to an opening position so that the blocking portion 121 uncovers the through opening 111. When the doorstop assembly 12 is in the opening position, the blocking portion 121 is oblique to an opening direction of the through opening 111.

Specifically, when the doorstop assembly 12 swings toward the opening position, the blocking portion 121 swings toward a direction away from the receiving space 112, and a plane which the blocking portion 121 is located on and a plane which the through opening 111 is located on define an input opening 3 therebetween. Preferably, an opening direction of the input opening 3 is opposite to a ground so that a user can take objects out or put objects in through the input opening 3 while standing. For example but not limited thereto, when the inductive receiving device is used as a garbage can, the user can throw garbage thereinto directly from a position right above the inductive receiving device. In addition, considering an average height of normal adults and user convenience, when the doorstop assembly 12 swings to the opening position, an included angle between the plane which the blocking portion 121 is located on and the plane which the through opening 111 is located on is preferably between 25 to 65 degrees (as shown in FIG. 5).

The actuating unit 2 has at least one contact portion 21, a processing unit 22 and a driving unit 23, the processing unit 22 is respectively in communication with the at least one contact portion 21 and the driving unit 23, the driving unit 23 is connected to the doorstop assembly 12. Specifically, the contact unit 21 is for being contacted from the outside of the main body 1, transferring a pressure variation into an opening signal and transmitting the opening signal to the processing unit 22, as the processing unit 22 receives the opening signal, the processing unit 22 transmits an actuating signal to the driving unit 23, and the driving unit 23 drives the doorstop assembly 12 to swing to the opening position. Through the above-mentioned inductive opening method, the user does not need to often the doorstop assembly 12 or the shell body 11, and it is more hygienic that when one of the user's hand, the doorstop assembly 12 and the shell body 11 has dirt thereon, the dirt is not easily mutually transferred and contaminated. In addition, the driving unit 23 drives the doorstop assembly 12 to swing to open with a preset force, so problems like applying too much force to cause a structure of the inductive receiving device to be damaged can be prevented.

It is to be noted that aside from wired electronic connection, the communication may be conducted through wireless connection, and wireless connection may be, for example (but not limited thereto), Bluetooth and WiFi. Therefore, the contact portion 21 can not only be electrically connected to the processing unit 22 directly but also be designed to function in the wireless connection way so that the user can control the contact portion 21 remotely. In this embodiment, the contact portion 21 is disposed on a lower portion of the shell body 11 for the user to step or contact by feet without using hands to control the doorstop assembly 12.

Preferably, the actuating unit 2 further has a time-control unit 28, the time-control unit 28 is in communication with the processing unit 22, when the driving unit 23 drives the doorstop assembly 12 to swing to the opening position, the time-control unit 28 starts to count; after the time-control unit 28 counts to a preset time, the time-control unit 28 sends out a closing signal to the processing unit 22; as the processing unit 22 receives the closing signal, the processing unit 22 transmits a returning signal to the driving unit 23, and the driving unit 23 drives the doorstop assembly 12 to swing back to an initial position where the blocking portion 121 blocks the through opening 111. Of course, the doorstop assembly 12 may return to the initial position not just through the driving unit 23; in other embodiments, the doorstop assembly 12 may be back to the initial position manually.

More preferably, the preset time changes in accordance with modes of the opening signal. In this embodiment, for example but not limited thereto, when the inductive receiving device is used as a garbage can, it can be set that when the opening signal indicates that the contact portion 21 is contacted once, the preset time is five seconds so that the user can throw in garbage quickly without letting odor of the garbage disseminate to the outside of the main body 1; and when the opening signal indicates that the contact portion 21 is intermittently contacted twice, the preset time is five minutes so that the user can conduct actions which require longer time, such as changing a garbage bag. If the user needs the doorstop assembly 12 to be in the opening position for more than 5 minutes, s/he can set that when the opening signal indicates that the contact portion 21 is contacted continuously, the preset time is infinite (or untimed), and when the opening signal ends, the time-control unit 28 immediately sends out the closing signal to the processing unit 22.

The driving unit 23 has a motor 24 and an actuating member 25, the actuating member 25 is respectively connected to a driving portion 241 of the motor 24 and the doorstop assembly 12, the driving portion 241, the actuating member 25 and the doorstop assembly 12 are in a co-moving relation, and as the motor 24 receives the actuating signal, the driving portion 241 runs and drives the actuating member 25 to move and drive the doorstop assembly 12 to swing to the opening position. On the contrary, when the motor 24 receives the returning signal, the driving portion 241 drives the doorstop assembly 12 to swing to the initial position. In addition, the actuating unit 2 further has a circuit board 29, the circuit board 20 is positioned on the motor 24, and the processing unit 22, each said contact portion 21, the time-control unit 28 and the motor 24 are respectively electrically connected to the circuit board 29.

More specifically, the driving unit 23 further has a gear set 26, the gear set 26 includes a first gear 261 and a second gear 262 which are meshed with each other, the first gear 261 is driven by the driving portion 241 to rotate, one of two ends of the actuating member 25 is assembled to the second gear 262 and is in co-rotating relation with the second gear 262, and the other of the two ends of the actuating member 25 is slidably assembled to the doorstop assembly 12. Preferably, and the second gear 262 is greater than the first gear 261 in radial dimension so that it is more energy-saving during the process of the motor 24 driving the actuating member 25 to move.

More preferably, the driving unit 23 further has a stretchable spring 27, and the stretchable spring 27 is respectively connected to the shell body 11 and the actuating member 25 so as to make the doorstop assembly 12 have a tendency to move toward the initial position to assist the doorstop assembly 12 to return to the initial position more quickly. In addition, the stretchable spring 27 can lower a speed of the doorstop assembly 12 swinging to the opening position so as to prevent the doorstop assembly 12 from swinging outwardly too quickly to hit the user hardly.

More specifically, the doorstop assembly 12 further has a bottom portion 122 which is laterally connected to the blocking portion 121, a stopping member 124 and a slidable base 123, the slidable base 123 and the blocking portion 121 are disposed on two side faces of the bottom portion 122 opposite to each other, the other of the two ends of the actuating member 25 is slidably arranged on the slidable base 123, the bottom portion 122 is for carrying an object, the stopping member 124 is disposed on a side wall of the bottom portion 122, when the doorstop assembly 12 is located in the initial position, and the stopping member 124 abuts against an inner wall of the shell body 11 to provide a positioning effect. As viewed along the opening direction of the through opening 111, the blocking portion 121 is connected to the bottom portion 122 to be in L shape.

Furthermore, when the object is a barrel body, the barrel body can further receive a plurality of items, and when the user wants to take out all the items, s/he only needs to take out the whole barrel body. In addition, the barrel body can isolate the items from the inductive receiving device so as to prevent from contaminating or damaging the inductive receiving device. In other words, the barrel body can protect integrity of the inductive receiving device.

Given the above, when the user wants to open the doorstop assembly of the inductive receiving device, s/he only needs to touch the contact portion without often contacting the inductive receiving device so as to prevent dirt from being transferred mutually. In addition, according to ways of contacting the contact portion, there are different modes of opening signals, so the user can control the time between opening the doorstop assembly and closing the doorstop assembly in accordance to different requirements.

While we have shown and described various embodiments in accordance with the present invention, it should be clear to those skilled in the art that further embodiments may be made without departing from the scope of the present invention.

What is claimed is:

1. An inductive receiving device, including:
a main body, having a shell body and a doorstop assembly, the shell body having a through opening and a receiving space, the through opening being for communicating an outside of the main body and the receiving space, a blocking portion of the doorstop assembly normally blocking the through opening, the doorstop assembly optionally swinging relative to the shell body to an opening position so that the blocking portion uncovers the through opening, wherein when the doorstop assembly is in the opening position, the blocking portion is oblique to an opening direction of the through opening;
an actuating unit, having at least one contact portion, a processing unit and a driving unit, the processing unit being respectively in communication with the at least one contact portion and the driving unit, the driving unit being connected to the doorstop assembly, wherein the contact portion is for being contacted from the outside of the main body, transferring a pressure variation into an opening signal and transmitting the opening signal to the processing unit, as the processing unit receives the opening signal, the processing unit transmits an actuating signal to the driving unit, and the driving unit drives the doorstop assembly to swing to the opening position.

2. The inductive receiving device of claim 1, wherein when the doorstop assembly swings toward the opening position, the blocking portion swings toward a direction away from the receiving space, a plane where the blocking portion is located on and a plane where the through opening is located on define an input opening therebetween, and an opening direction of the input opening is opposite to a ground.

3. The inductive receiving device of claim 2, wherein when the doorstop assembling swings to the opening position, the plane where the blocking portion is located on and the plane where the through opening is located on define an included angle which is between 25 to 65 degrees.

4. The inductive receiving device of claim 1, wherein the driving unit has a motor and an actuating member, the actuating member is respectively connected to a driving portion of the motor and the doorstop assembly, the driving portion, the actuating member and the doorstop assembly are in a co-moving relation, and as the motor receives the actuating signal, the driving portion runs and drives the actuating member to move and drive the doorstop assembly to swing to the opening position.

5. The inductive receiving device of claim 4, wherein the driving unit further has a gear set, the gear set includes a first gear and a second gear which are meshed with each other, the first gear is driven by the driving portion to rotate, one of two ends of the actuating member is assembled to the second gear and is in co-rotating relation with the second gear, the other of the two ends of the actuating member is slidably assembled to the doorstop assembly, and the second gear is greater than the first gear in radial dimension.

6. The inductive receiving device of claim 1, wherein the actuating unit further has a time-control unit, the time-control unit is in communication with the processing unit, when the driving unit drives the doorstop assembly to swing to the opening position, the time-control unit starts to count; after the time-control unit counts to a preset time, the time-control unit sends out a closing signal to the processing unit; as the processing unit receives the closing signal, the processing unit transmits a returning signal to the driving unit, and the driving unit drives the doorstop assembly to swing back to an initial position where the blocking portion blocks the through opening.

7. The inductive receiving device of claim 6, wherein the preset time changes in accordance with modes of the opening signal, and when the opening signal indicates that the contact portion is contacted once, the preset time is five seconds.

8. The inductive receiving device of claim 6, wherein the preset time changes in accordance with modes of the opening signal, and when the opening signal indicates that the contact portion is intermittently contacted twice, the preset time is five minutes.

9. The inductive receiving device of claim 6, wherein the preset time changes in accordance with modes of the opening signal, when the opening signal indicates that the contact portion is contacted continuously, the preset time is infinite, and when the opening signal ends, the time-control unit immediately sends out the closing signal to the processing unit.

10. The inductive receiving device of claim 9, wherein when the opening signal indicates that the contact portion is contacted once, the preset time is five seconds; when the opening signal indicates that the contact portion is intermittently contacted twice, the preset time is five minutes; when the doorstop assembly swings toward the opening position, the blocking portion swings toward a direction away from the receiving space, a plane where the blocking portion is located on and a plane where the through opening is located on define an input opening therebetween, and an opening direction of the input opening is opposite to a ground; the plane where the blocking portion is located on and the plane where the through opening is located on define an included angle which is between 25 to 65 degrees; the driving unit has a motor and an actuating member, the actuating member is respectively connected to a driving portion of the motor and the doorstop assembly, the driving portion, the actuating member and the doorstop assembly are in a co-moving relation, and as the motor receives the actuating signal, the driving portion runs and drives the actuating member to move and drive the doorstop assembly to swing to the opening position; the driving unit further has a gear set, the gear set includes a first gear and a second gear which are meshed with each other, the first gear is driven by the driving portion to rotate, one of two ends of the actuating member is assembled to the second gear and is in co-rotating relation with the second gear, the other of the two ends of the actuating member is slidably assembled to the doorstop assembly, and the second gear is greater than the first gear in radial dimension; the actuating unit further has a circuit board, and the processing unit, each said contact portion, the time-control unit and the motor are respectively electrically connected to the circuit board; the driving unit further has a stretchable spring, and the stretchable spring is respectively connected to the shell body and the actuating member so as to make the doorstop assembly have a tendency to move toward the initial position; the doorstop assembly further has a bottom portion which is laterally connected to the blocking portion, a stopping member and a slidable base, the slidable base and the blocking portion are disposed on two side faces of the bottom portion opposite to each other, the other of the two ends of the actuating member is slidably arranged on the slidable base, the bottom portion is for carrying an object, the stopping member is disposed on a side wall of the bottom portion, when the doorstop assembly is located in the initial position, the stopping member abuts against an inner wall of the shell body, and as viewed along the opening direction of the through opening, the blocking portion is connected to the bottom portion to be in L shape.
